(19) United States
(12) Patent Application Publication
(10) Pub. No.: US 2022/0150846 A1
(43) Pub. Date: May 12, 2022

(54) RADIO COMMUNICATION TECHNIQUE WITH DIFFERENT COVERAGE LEVELS

(71) Applicant: Telefonaktiebolaget LM Ericsson (publ), Stockholm (SE)

(72) Inventors: Sara SANDBERG, Luleå (SE); David SANDBERG, Sundbyberg (SE); Stefan WÄNSTEDT, Luleå (SE); Peter ÖKVIST, Luleå (SE); Magnus THURFJELL, Luleå (SE)

(73) Assignee: Telefonaktiebolaget LM Ericsson (publ), Stockholm (SE)

(21) Appl. No.: 17/439,104

(22) PCT Filed: Mar. 15, 2019
(86) PCT No.: PCT/EP2019/056561

§ 371 Date: Sep. 14, 2021

(51) Int. Cl. H04W 52/24; H04W 48/12; H04W 52/14

(52) U.S. Cl. CPC H04W 52/245; H04W 52/143; H04W 48/12; H04W 52/241

(57) ABSTRACT

A technique for controlling and selecting a coverage level (502, 504, 506) for a radio device connected or connectable to an access node over a radio medium is described. As to one method aspect of the technique, a state or usage of at least one of the radio medium and the access node is determined. Control information is transmitted to the radio device. The control information is indicative of at least one threshold value (512, 514) that depends on the determined state or usage for controlling the coverage level (502, 504, 506) selected by the radio device based on a comparison of power (510) of a downlink signal received over the radio medium from the access node with the at least one threshold value (512, 514).

### TECHNICAL FIELD

The present disclosure generally relates to a radio communication with different coverage levels. More specifically, methods and devices are provided for controlling or selecting a coverage level used by a radio device connected or connectable to an access node.

### BACKGROUND

Cellular communication systems comprise one or more access nodes each configured to serve within a cell at least one radio device that is also referred to as a user equipment (UE). Cellular communication systems are currently being developed and improved for machine-type communication (MTC). Enhanced MTC (eMTC) comprises applications with data rates less demanding than those for a mobile broadband (MBB) communication and yet has to fulfill specific requirements, e.g., on reduced design costs of the radio device, better coverage and the ability to operate for years on batteries without charging or replacing the batteries. Furthermore, the Third Generation Partnership Project (3GPP) is specifying a narrowband radio communication for the so-called Internet of Things (NB-IoT) with the objective to satisfy all or a subset of the requirements put forward by eMTC type applications, while maintaining backward compatibility with the current Long Term Evolution (LTE) radio access technology.

The 3GPP specification for NB-IoT encompasses radio access for cellular IoT, which addresses at least one of improved indoor coverage, support for a large number of low throughput devices, low delay sensitivity, ultra-low device cost, low device power consumption and optimized network architecture. A radio device accessing the cell for eMTC or NB-IoT follows same principle as for 3GPP LTE. The radio device searches for a cell on a certain frequency, reads associated system information (SI) and starts a random access (RA) procedure on a RA channel (RACH) to establish a radio resource control (RRC) connection.

Both eMTC and NB-IoT support coverage enhancements that are selectively applied according to different coverage levels. For example, the radio device accumulates several repetitions of the SI that are broadcast by the access node to enable the radio device to successfully decode the SI. However, such measures for coverage enhancement increase the SI acquisition time as the coverage of the radio device becomes worse. To combat this, denser replications (e.g., arranged closer in the frequency domain or more frequent repetitions in the time domain) of certain physical channels (e.g., SI over a physical broadcast channel or PBCH) were introduced for eMTC and NB-IoT in 3GPP Release 13.

The drawback of the denser replications is an increased system overhead, i.e. more radio resources are occupied by (e.g., “always-on”) control signaling. For example, if a too high coverage level is selected, unnecessarily many radio resources are allocated to control signaling, and if a too low coverage level is selected, the radio device may never detect the cell.

The RA procedure is also controlled by RA parameters (also: RACH parameters) that depend on the coverage level. Selecting the coverage level at the radio device based only on reference signal received power (RSRP, e.g., an NRSRP for NB-IoT) works fine if the interference is low. This is likely to be the case as long as the number of radio devices connected to each cell is low.

However, as the load in the cell (e.g., a NB-IoT network) increases, the interference will increase as well. Particularly, if suboptimal values for the RA parameters are selected, the RACH resources used for transmission of RA preambles are not optimally used and congestions will occur at a lower RA load compared to using optimal RA parameters.

For example, if a too low coverage level is selected, the radio device may have to perform several RA attempts with increasing number of repetitions, before the access node successfully receives the RA preamble and transmits a RA response, i.e., before the radio device receives the RA response, if at all. However, several RA attempts are costly in terms of power consumption for the radio device. Moreover, the several RA attempts add unnecessarily to the total network interference, i.e., reduce the availability of RACH resources. For radio devices with very poor radio conditions (such as deep-indoor UEs), the interference can even exclude such radio devices from being able to access the access node.

On the other hand, if a too high coverage level is selected, unnecessarily many preamble repetitions may be used, which is also costly in terms of power consumption and adds to the total network interference.

### SUMMARY

Accordingly, there is a need for a radio coverage level selection technique that reduces in at least some situations at least one of power consumption of radio devices, control signaling overhead and interference between radio devices.

As to a first method aspect, a method of controlling a coverage level for a radio device connected or connectable to an access node over a radio medium is provided. The method comprises a step of determining a state or usage of at least one of the radio medium and the access node. The method further comprises a step of transmitting control information to the radio device. The control information is indicative of at least one threshold value. The at least one threshold value depends on the determined state or usage for controlling the coverage level selected by the radio device based on a comparison of power of a downlink signal received over the radio medium from the access node with the at least one threshold value.

The power of the downlink signal received over the radio medium (e.g. the RS received power or RSRP, particularly the Narrowband RSRP or NRSRP) may be briefly referred to as the received power at the radio device. At the radio device, the coverage level may be selected by comparing any one or each of the at least one threshold value with the received power.

The coverage level may also be referred to as a coverage enhancement (CE) level. Technical means for implementing the coverage level may also be referred to as CE.

The control information may be indicative of one threshold value or two or more different threshold values. The at least one threshold value for selecting the coverage level may also be referred to as coverage level threshold value.

The at least one threshold value may control the selection of the coverage level. By transmitting the at least one threshold value used for the selection of the coverage level according to the technique, the selection of the coverage level can be controlled. Since the at least one threshold value depends on the determined state or usage, a selection of a too high coverage level caused by a too low threshold value can be prevented, so that unnecessary repetitions of control signals (e.g., SI repetitions or RA preamble repetitions) can be avoided. Hence, radio resource efficiency can be improved, power consumption can be reduced and/or total network interference can be reduced.

By selecting the coverage level based on the power received from the access node over the radio medium, the selected coverage level may depend on a path loss of the radio medium between the access node and the radio device in at least some embodiments. Furthermore, by selecting the coverage level based on the comparison with the at least one threshold value, the radio device may take the state (e.g., a channel state of an uplink) or the usage (e.g., status or load) of the radio medium and/or the access node into account when selecting its coverage level.

Embodiments can overcome the drawback associated with a conventional RSRP-based coverage level selection, which is that the coverage level selected at the radio device does not take into account the actual interference situation at the access node, e.g., during the transmission of the RA preambles.

The access node may perform the first method aspect. A radio access network (RAN) may comprise the access node or multiple embodiments of the access node. The RAN may comprise a plurality of access nodes. The radio device may be connected or connectable (e.g., currently unconnected) to the RAN.

At the time of performing the method, the radio device may be unconnected (or idle) or connected to the access node from which the signal is received. For example, the radio device may camp on a cell of the access node. Alternatively, or in addition, at the time of performing the method, the radio device may be connected to another access node of the RAN. For example, the radio device may establish a dual connectivity, may perform a handover from the other access node to the access node, or may recover from a radio link failure (RLF) by accessing the access node or re-accessing the access node (e.g., as the currently serving access node).

The determined state or usage may be at least one of measured at the access node and reported to the access node.

The radio medium may comprise one or more physical channels, e.g., a radio spectrum, and/or one or more radio links (e.g., a radio beam). The channel may comprise a downlink (DL) channel (e.g., a DL carrier) from the access node to the radio device and/or an uplink (UL) channel (e.g., an UL carrier) from the radio device to the access node. For example, the radio medium may comprise a physical broadcast channel (PBCH) and a physical random access channel (PRACH).

The at least one threshold value may depend on the determined state or usage of the radio medium at the access node or the determined state or usage of the access node over the radio medium.

In same or further embodiments, by selecting the coverage level based on the comparison with the at least one threshold value that depends on the determined state or usage of the radio medium at the access node, the selected coverage level may further depend on the local state or usage of the radio medium at the access node, e.g., which may be conventionally unknown at the radio device.

The determined state or usage of the radio medium and/or the determined state or usage of the access node may comprise or may relate to at least one of: a load of the access node over the radio medium; a number of radio links over the radio medium, which are terminated at the access node; an occupancy of the radio medium at the access node; an interference level on the radio medium at the access node or in a cell served by the access node; and a collision rate on the radio medium at the access node. The radio links may be radio beams or spatial streams, e.g., defined by at least one of beamforming transmission, beamforming reception and a multiple-input multiple-output (MIMO) channel. The interference level on the radio medium may be based on a signal to interference and noise ratio (SINR). The radio medium may comprise an uplink carrier to the access node. The interference level may be based on an average interference on the uplink carrier at the access node.

The state or usage of the radio medium may be determined based on a power of an uplink signal received over the radio medium at the access node. The uplink signal received at the access node may be transmitted from the radio device.

The uplink signal may comprise a RA preamble transmitted from the radio device and at least one of noise and interference. The noise and interference may be transmitted by one or more devices other than the radio device.

The at least one threshold value may be decreased if a channel quality as the determined state of the radio medium decreases. Alternatively, or in addition, the at least one threshold value may be decreased if the determined usage increases. For example, any one or each of the at least one threshold value may be decreased responsive to an increase of at least one of the interference level at the access node and the load of the access node.

Each of the at least one threshold value may define a lower limit for a power range. Each of the at least two power ranges is associated with a coverage level. If the received power is in the respective power range, the coverage level associated with the respective power range is selected. For example, the radio device receives two (or n−1) threshold values Th₁ and Th₂ for discriminating the RSRP into three (or n) regions corresponding to three (or n) different coverage levels.

The controlled coverage level may be increased responsive to an increase in a channel quality as the determined state of the radio medium and/or an increase in the determined usage. Alternatively, or in addition, the controlled coverage level may be increased responsive to an increase in the determined state or usage by transmitting the control information in response to the increase in the determined state or usage.

The state or usage may be determined based on current measurements of the radio medium at the access node and/or past measurements of the radio medium at the access node. Herein, measurements at the access node may encompass any observation of the access node directly or indirectly related to the radio medium.

The past measurements may also be referred to as historical measurements. The past measurements may comprise measurements collected about past events. Using past measurements can enable predicting an interference situation, e.g. for NB-IoT, whereas a conventional RSRP-based coverage level selection may fail to predict or detect the interference situation, since each transmission (from the radio device and/or the access node) is supposed to be short.

The access node may predict the usage based on past and/or current measurements for determining the at least one threshold value. The past measurements may be associated with or mapped to recurrent events and/or periodic time intervals. The usage may be predicted based on the recurrence of the events or the periodicity of the time intervals. Each of the periodic time intervals may encompass 24 hours (i.e., one day) or 7 days (i.e., one week). The past measurements may be time-averaged or associated with a periodic time resolution. For example, the past measurements may be associated with or mapped to a periodic time axis (e.g., time of day and/or day of week).

The usage of the access node may be caused by a number of (e.g., other) radio devices currently, periodically or recurrently connected to the access node. Alternatively, or in addition, the usage of the access node may comprise a rate at which (e.g., other) radio devices currently, periodically or recurrently access the access node. Periodically connected or periodically accessing may encompass historical data depending on time of day and/or day of week.

The method may further comprise a step of transmitting the downlink signal to the radio device for enabling a measurement of power of the downlink signal as received at the radio device. The downlink signal may comprise at least one of a synchronization signal and a reference signal. The radio device may measure the power of reference signals (RSs) received from the access node. The measured power may also be referred to as RS received power (RSRP). Alternatively, or in addition, the radio device may measure the power of synchronization signal blocks (SS blocks).

The control information may be comprised in system information (SI). Alternatively or in addition, the control information may be broadcasted. The access node may transmit (e.g., broadcast) the at least one threshold value in SI, e.g., in the SI Block 2 (SIB2).

Controlling the coverage level may comprise or initiate, e.g., at the access node, allocating radio resources for a transmission over the radio medium to the access node. The allocated radio resources may depend on the coverage level selected at the radio device based on the control information.

The method may further comprise a step of receiving a message from the radio device over the radio medium at the access node according to the controlled coverage level. Radio resources used for the reception of the message may depend on the controlled coverage level. For example, the allocated radio resource may be used for the transmission of the message.

The reception of the message may use at least one of a robustness and an amount of redundancy, e.g. a (certain) number of repetitions, according to the controlled coverage level. The coverage level may determine at least one of a robustness and a redundancy for the transmission from the radio device over the radio medium to the access node.

An increase of the controlled coverage level may cause or may be associated with an increase in at least one of the robustness, the amount of redundancy and the radio resources.

Correspondingly, from the perspective of the radio device, the transmission of the message may use at least one of a robustness and an amount of redundancy, e.g. a (certain) number of repetitions, according to the controlled coverage level. The coverage level may determine at least one of a robustness and a redundancy for the transmission from the from the radio device over the radio medium to the access node.

The controlled coverage level may determine at least one of an initial value for a power ramp underlying a transmission of the message; a (certain) number of repetitions for the reception of the message; and a bandwidth used in the reception of the message.

Correspondingly, from the perspective of the radio device, the controlled coverage level may determine at least one of an initial value for a power ramp underlying a transmission of the message; a (certain) number of repetitions for a transmission of the message; and a bandwidth used in the transmission of the message.

The message may be a random access (RA) preamble.

The radio device (e.g., a user equipment or UE) may transmit the message (e.g., the RA preamble) in different radio resources (e.g., different physical resource blocks, PRBs) depending on which coverage level the radio device prefers or has selected. The access node (e.g., an eNB or gNB) may determine from the radio resources on which the access node receives the message which coverage level has been selected and/or is to be used.

One or more different transmission parameters of the radio device may depend on the selected coverage level. The transmission parameters may comprise RA parameters, e.g. for preamble ramping, a preamble initial received target power and a number of preamble attempts. The RA parameters may be set by the access node (e.g., an eNB) to improve RA performance. Optimal values for these RA parameters may depend on an average load on the RACH in the cell and/or the RACH interference, which in turn may depend on at least one of average data packet size, a number of (e.g., NB-IoT) radio devices in the cell and the radio conditions (path loss) of each device.

The method may further comprise a step of receiving a random access, e.g. a random access preamble, from the radio device according to the controlled coverage level.

The method may further comprise a step of performing a RA procedure using the selected coverage level. For example, the transmitted message may be a RA preamble.

A first threshold value and a second threshold value may be used for controlling the coverage level. The control information may be indicative of the first threshold value. The second threshold value may be defined by a predefined offset value relative to the first threshold value. The control information may be indicative of only first threshold value. The control information may imply the second threshold value based on the first threshold value and the predefined offset.

The control information may be indicative of the at least one threshold value by indicating an offset value relative to a predefined default threshold value.

The access node may be accessed by a plurality of radio devices according to the respectively selected coverage level. The usage may be measured at the access node for each of the different coverage levels. For example, the usage may encompass the number of (e.g., successful) accesses per coverage level.

The at least one threshold value in the control information may be changed relative to at least one previous threshold value to equalize the usage of the coverage levels.

A previously transmitted control information may be indicative of the at least one previous threshold value. The usage may be measured at the access node for each of the different coverage levels based on the previous control information and/or after the access node has transmitted (e.g., broadcast) the previous control information, e.g., to each of a plurality of radio devices. For example, the at least one changed threshold value, as indicated in the control information, may be changed to decrease a power range for the coverage level for which the access node has measured the greatest usage. Alternatively or in addition, the at least one changed threshold value, as indicated in the control information, may be changed to increase a power range for the coverage level for which the access node has measured the smallest usage. For example, changing the at least one threshold value may comprise shifting a threshold value that defines a border between a first power range for a first coverage level that has more usage than a second coverage level into the first power range. Thus, a second power range associated with the second coverage level may be increased.

The information as to the usage measured at the access node may be exchanged with at least one neighboring access node. The neighboring access node may serve a cell that is adjacent to the cell served by the access node. The exchanged information as to the usage may relate to a coverage level that corresponds to a cell border between the cells. The usage may be exchanged between the access node and the at least one neighboring access node through an X2 interface.

As to a second method aspect, a method of selecting a coverage level for a radio device connected or connectable to an access node over a radio medium is provided. The method comprises a step of receiving control information from the access node. The control information is indicative of at least one threshold value that depends on a state or usage of at least one of the radio medium and the access node. The method further comprises a step of selecting the coverage level based on a comparison of power of a downlink signal received over the radio medium from the access node with the at least one threshold value.

The second method aspect may be performed by the radio device or each of a plurality of radio devices.

The second method aspect may further comprise any feature or step disclosed in the context of the first method aspect or any feature or step corresponding thereto.

As to a third method aspect, a method of controlling and selecting a coverage level for a radio device connected or connectable to an access node over a radio medium is provided. The method may comprise the determining step and the transmission step of the first method aspect followed by the receiving step and the selecting step of the second method aspect.

In any aspect, the access node may be implemented by a base station, a cell or a remote radio head. The access node may be any station that is configured to provide radio access to the radio device. The access node implementing the first method aspect of the technique may serve a plurality of radio devices, e.g., each implementing the second method aspect of the technique.

Examples for the access node may include a 3G base station or Node B, 4G base station or eNodeB, a 5G base station or gNodeB, an access point (e.g., a Wi-Fi access point) and a network controller (e.g., according to Bluetooth, ZigBee or Z-Wave).

The radio device may be configured for accessing the RAN (e.g., on an uplink and/or a downlink). The radio device may be a user equipment (UE, e.g., a 3GPP UE), a mobile or portable station (STA, e.g. a Wi-Fi STA), a device for machine-type communication (MTC), a device for narrowband Internet of Things (NB-IoT) or a combination thereof. Examples for the MTC device or the NB-IoT device include robots, sensors and/or actuators, e.g., in manufacturing, automotive communication and home automation. The MTC device or the NB-IoT device may be implemented in household appliances and consumer electronics.

The RAN may be implemented according to the Global System for Mobile Communications (GSM), the Universal Mobile Telecommunications System (UMTS), Long Term Evolution (LTE) and/or New Radio (NR).

The technique may be implemented on a Physical Layer (PHY), a Medium Access Control (MAC) layer, a Radio Link Control (RLC) layer and/or a Radio Resource Control (RRC) layer of a protocol stack for the radio communication.

As to another aspect, a computer program product is provided. The computer program product comprises program code portions for performing any one of the steps of the first method aspect and/or the second method aspect disclosed herein when the computer program product is executed by one or more computing devices. The computer program product may be stored on a computer-readable recording medium. The computer program product may also be provided for download via a data network, e.g., via the access node, via the RAN and/or via the Internet. Alternatively or in addition, the method may be encoded in a Field-Programmable Gate Array (FPGA) and/or an Application-Specific Integrated Circuit (ASIC), or the functionality may be provided for download by means of a hardware description language.

As to a first device aspect, a device for controlling a coverage level for a radio device connected or connectable to an access node over a radio medium is provided. The device may be configured to perform the first method aspect. For example, the device may comprise units configured to perform or initiate respective steps of the first method aspect.

As to a second device aspect, a device for selecting a coverage level for a radio device connected or connectable to an access node over a radio medium is provided. The device may be configured to perform the second method aspect. For example, the device may comprise units configured to perform or initiate respective steps of the second method aspect.

As to a further first device aspect, a device for controlling a coverage level for a radio device connected or connectable to an access node over a radio medium is provided. The device comprises at least one processor and a memory. Said memory comprises instructions executable by said at least one processor whereby the device is operative to perform the first method aspect.

As to a further second device aspect, a device for selecting a coverage level for a radio device connected or connectable to an access node over a radio medium is provided. The device comprises at least one processor and a memory. Said memory comprises instructions executable by said at least one processor whereby the device is operative to perform the second method aspect.

As to a still further device aspect, a base station (BS) configured to communicate with a user equipment (UE) is provided. The BS comprises a radio interface and processing circuitry configured to execute any one of the steps of the first method aspect.

As to a still further device aspect, a user equipment (UE) configured to communicate with a base station (BS) is provided. The UE comprises a radio interface and processing circuitry configured to execute any one of the steps of the second method aspect.

As to a still further aspect, a system for controlling and selecting a coverage level for a radio device connected or connectable to an access node over a radio medium is provided. The system may comprise a controlling station (e.g., a BS) configured to perform the first method aspect and a selecting station (e.g., a UE) configured to perform the second method aspect.

As to a still further aspect a communication system including a host computer is provided. The host computer may comprise a processing circuitry configured to provide user data. The host computer may further comprise a communication interface configured to forward user data to a cellular network for transmission to a user equipment (UE), wherein the UE comprises a radio interface and processing circuitry, the processing circuitry of the UE being configured to execute any one of the steps of the second method aspect.

The communication system may further include the UE. Alternatively or in addition, the cellular network may further include the BS.

The processing circuitry of the host computer may be configured to execute a host application, thereby providing the user data. Alternatively or in addition, the processing circuitry of the UE may be configured to execute a client application associated with the host application.

As to a still further aspect a method implemented in a base station (BS) is provided. The method may comprise any of the steps of the first method aspect.

As to a still further aspect a method implemented in a user equipment (UE) is provided. The method may comprise any of the steps of the second method aspect.

Any one of the devices, the BS, the UE, the system, the communication system or any node or station for embodying the technique may further include any feature disclosed in the context of any one of the method aspects, and vice versa. Particularly, any one of the units and modules, or a dedicated unit or module, may be configured to perform or initiate one or more of the steps of any one of the method aspects.

### BRIEF DESCRIPTION OF THE DRAWINGS

Further details of embodiments of the technique are described with reference to the enclosed drawings, wherein:

FIG. 1 shows a schematic block diagram of an embodiment of a device for controlling a coverage level for a radio device connected or connectable to an access node over a radio medium;

FIG. 2 shows a schematic block diagram of an embodiment of a device for selecting a coverage level for a radio device connected or connectable to an access node over a radio medium;

FIG. 3 shows a flowchart for an exemplary implementation of a method of controlling a coverage level for a radio device connected or connectable to an access node over a radio medium, which method may be implementable by the device of FIG. 1;

FIG. 4 shows a flowchart for an exemplary implementation of a method of selecting a coverage level for a radio device connected or connectable to an access node over a radio medium, which method may be implementable by the device of FIG. 2;

FIG. 5 schematically illustrates a relation between threshold values for a received power and coverage levels in terms of a path loss, which may be implementable in any of the devices of FIGS. 1 and 2;

FIG. 6 schematically illustrates a relation between radio resources and coverage levels, which may be implementable in any of the devices of FIGS. 1 and 2;

FIG. 7 shows a schematic signaling diagram for a random access procedure, which may be implementable in any of the devices of FIGS. 1 and 2;

FIG. 8 shows a flowchart for an exemplary implementation of the method of FIG. 3;

FIG. 9 shows a schematic block diagram of an embodiment of the device of FIG. 1;

FIG. 10 shows a schematic block diagram of an embodiment of the device of FIG. 2;

FIG. 11 schematically illustrates an exemplary telecommunication network connected via an intermediate network to a host computer;

FIG. 12 shows a generalized block diagram of an embodiment of a host computer communicating via a base station with a user equipment over a partially wireless connection; and

FIGS. 13 and 14 show flowcharts for methods implemented in a communication system including a host computer, a base station and a user equipment.

### DETAILED DESCRIPTION

In the following description, for purposes of explanation and not limitation, specific details are set forth, such as a specific network environment in order to provide a thorough understanding of the technique disclosed herein. It will be apparent to one skilled in the art that the technique may be practiced in other embodiments that depart from these specific details. Moreover, while the following embodiments are primarily described for a machine type communication (MTC) and the Internet of Things (IoT), particularly in the context of a New Radio (NR) or 5G implementation, it is readily apparent that the technique described herein may also be implemented in any other radio network, including Third Generation Partnership Project (3GPP) Long Term Evolution (LTE) or a successor thereof, Wireless Local Area Network (WLAN) according to the standard family IEEE 802.11, Bluetooth according to the Bluetooth Special Interest Group (SIG), particularly Bluetooth Low Energy and Bluetooth broadcasting, and/or ZigBee based on IEEE 802.15.4.

Moreover, those skilled in the art will appreciate that the functions, steps, units and modules explained herein may be implemented using software functioning in conjunction with a programmed microprocessor, an Application Specific Integrated Circuit (ASIC), a Field Programmable Gate Array (FPGA), a Digital Signal Processor (DSP) or a general purpose computer, e.g., including an Advanced RISC Machine (ARM). It will also be appreciated that, while the following embodiments are primarily described in context with methods and devices, the invention may also be embodied in a computer program product as well as in a system comprising at least one computer processor and memory coupled to the at least one processor, wherein the memory is encoded with one or more programs that may perform the functions and steps or implement the units and modules disclosed herein.

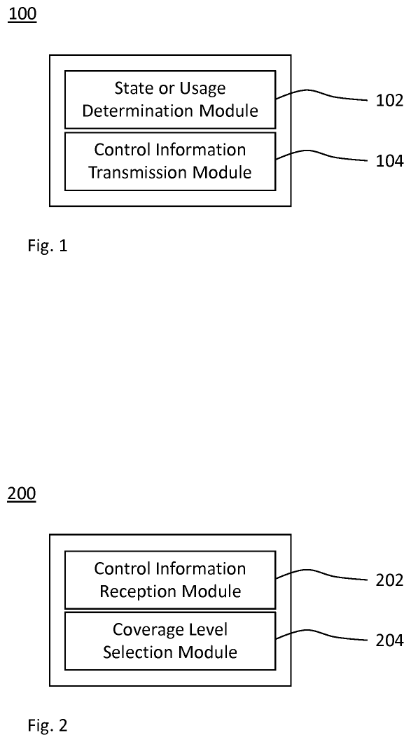

FIG. 1 schematically illustrates a block diagram of an embodiment of a device for controlling a coverage level for a radio device connected or connectable to an access node over a radio medium. The device is generically referred to by reference sign 100.

The device 100 comprises a state or usage determination module 102 that determines a state or usage of at least one of the radio medium and the access node. The device 100 further comprises a control information transmission module 104 that transmits control information to the radio device. The control information is indicative of at least one threshold value that depends on the determined state or usage for controlling the coverage level selected by the radio device based on a comparison of power of a downlink signal received over the radio medium from the access node with the at least one threshold value.

Any of the modules of the device 100 may be implemented by units configured to provide the corresponding functionality.

FIG. 2 schematically illustrates a block diagram of an embodiment of a device for selecting a coverage level for a radio device connected or connectable to an access node over a radio medium. The device is generically referred to by reference sign 200.

The device 200 comprises a control information reception module 202 that receives control information from the access node. The control information is indicative of at least one threshold value that depends on a state or usage of at least one of the radio medium and the access node. The device 200 further comprises a coverage level selection module 204 that selects the coverage level based on a comparison of power of a downlink signal received over the radio medium from the access node with the at least one threshold value.

Any of the modules of the device 200 may be implemented by units configured to provide the corresponding functionality.

While the technique is primarily described for a random access (RA) procedure, the coverage level may be controlled and selected, respectively, for any uplink (UL) or downlink (DL) radio signal or any UL or DL radio communication. Particularly, any measures for coverage enhancement (CE) according to the coverage level, which is controlled and selected based on the at least one threshold value, may be applied to any radio signal or any radio transmission.

In one aspect, the device 100 may be part of a radio access network (RAN). The device 100 may be embodied by or at the access node (e.g., a base station) of the RAN, nodes connected to the RAN for controlling the access node or a combination thereof.

In another aspect, which is combinable with the one aspect, the device 200 may be wirelessly connected or connectable to a RAN. The device 200 may be embodied by or at the radio device configured for accessing the RAN, for example in a vehicle configured for radio-connected driving.

In a further aspect, which is combinable with the one and/or the other aspect, the device 200 may be wirelessly connected or connectable to another radio device, for example another vehicle. The device 200 may be embodied by or at a radio device configured for wireless ad hoc connections.

The access node 100 may encompass a network controller (e.g., a Wi-Fi access point) or a radio access node (e.g. a 3G Node B, a 4G eNodeB or a 5G gNodeB) of the RAN. The base station may be configured to provide radio access to the radio device 200. Alternatively or in addition, the radio devices 200 may include a mobile or portable station or a radio device connectable to the RAN. Each radio device 200 may be a user equipment (UE), a device for machine-type communication (MTC) and/or a device for (e.g., narrowband) Internet of Things (IoT).

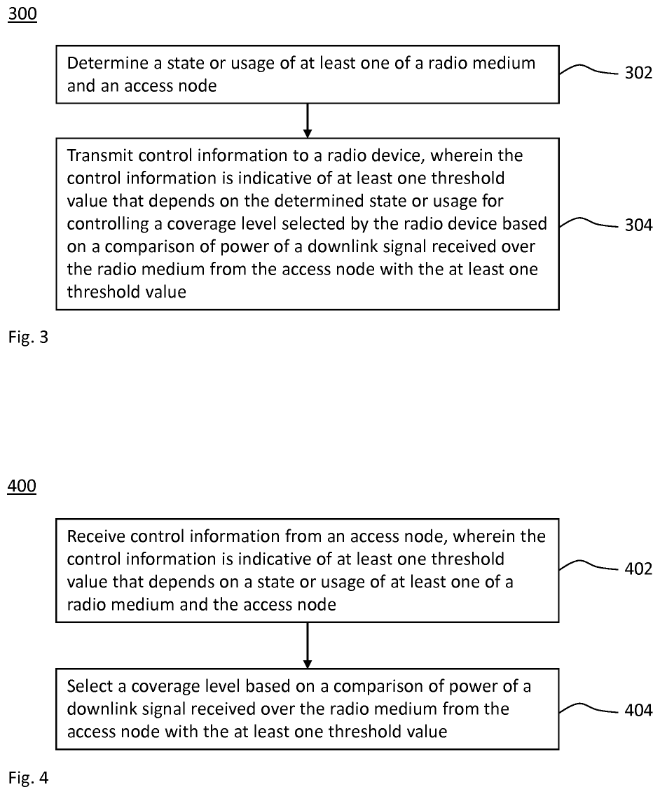

FIG. 3 shows a flowchart for a method 300 of controlling a coverage level of a radio device connected or connectable to an access node over a radio medium. The method comprises a step 302 of determining a state or usage of at least one of the radio medium and the access node. The method further comprises a step 304 of transmitting control information to the radio device. The control information is indicative of at least one threshold value that depends on the determined state or usage for controlling the coverage level selected by the radio device based on a comparison of power of a downlink signal received over the radio medium from the access node with the at least one threshold value.

The method 300 may be performed by the device 100, e.g., at or using the access node or the RAN. For example, the modules 102 and 104 may perform the steps 302 and 304, respectively.

FIG. 4 shows a flowchart for a method 400 of selecting a coverage level of a radio device connected or connectable to an access node over a radio medium. The method comprises a step 402 of receiving control information from the access node. The control information is indicative of at least one threshold value that depends on a state or usage of at least one of the radio medium and the access node. The method further comprises a step 404 of selecting the coverage level based on a comparison of power of a downlink signal received over the radio medium from the access node with the at least one threshold value.

The method 400 may be performed by the device 200, e.g., at or using the radio device for accessing the access node or the RAN. For example, the modules 202 and 204 may perform the steps 402 and 404, respectively.

In any aspect of the technique, the coverage level may also be referred to as a coverage enhancement (CE) level.

If the load in the RAN, particularly the load at the access node 100 or the occupancy of the radio medium at the access node 100, is high, embodiments of the radio device 200 (e.g., NB-IoT devices) may beneficially increase the coverage level selected by the radio device 200 under the control of the access node 100 (e.g., already from the start of a random access procedure) to reduce power consumption (e.g., at the radio device 200), retransmission delay and/or interference (e.g., at the access node 100, in the cell or in the RAN).

The increase in the coverage level may be controlled by a decrease in the at least one threshold value that is signaled in the control information from the access node 100 to the radio device 200. At the radio device 200, the increase in the coverage level responsive to the received decrease in the threshold value may be implemented by an increase in (e.g., the number of) the radio resources used for a transmission. The radio resources may be increased in the frequency domain (e.g., by increasing the number of subcarriers) and/or in the time domain (e.g., by increasing the number of repetitions, e.g., of a random access preamble).

The first aspect of the technique may be implemented by the access node 100, e.g., a base station such as an eNB or gNB, adjusting (i.e., changing) the at least one threshold value (e.g., NRSRP threshold values) used for estimation or determination of the coverage level, e.g., to give some margin when the cell load and/or interference is high.

From the perspective of the access node 100 (e.g., an eNB or gNB), the access node 100 may record a load history and/or how its load (e.g., an NB-IoT load) varies over a certain time period (e.g., a 24-hour period and/or per hour, etc.). Alternatively or in addition, the access node 100 may record an interference history and/or how the interference on the radio medium at the access node 100 varies over a certain time period (e.g., a 24-hour period and/or per hour, etc.). The load and the interference are examples for the state or usage of the access node 100 and/or the radio medium.

The access node 100 may decrease the at least one threshold value (e.g., a threshold value for the RSRP, particularly for the NRSRP) transmitted in the control information when the load and/or the interference increases (e.g., exceeds a predefined load threshold or an interference threshold). Vice versa, the access node 100 may increase the at least one threshold value when the load and/or the interference becomes less again (e.g., falls below the predefined load threshold or the interference threshold).

The predefined load threshold may be defined based on the load history, e.g., by a long-term average of the load. The predefined interference threshold may be defined based on the interference history, e.g., by a long-term average of the interference. The interference may be measured, e.g., at the access node 100. Interference measures may include at least one of geometry, RSRP (particularly NRSRP), reference signal received quality (RSRQ, particularly NB-IoT RSRQ or NRSRQ) and signal-to-interference and noise ratio (SINR). The long-term average load may be used, e.g., in combination with an average of the interference measure, to adjust the at least one threshold value.

In other words, the access node 100 (e.g., an eNB or a gNB) adjusts or changes by means of the transmission 304 the at least one threshold value (e.g., NRSRP thresholds) that is used for the selection 404 (e.g., a coverage level estimation) based on a current cell load and/or a historical cell load.

Alternatively or in addition, the access node 100 (e.g., an eNB or a gNB) determines the state of the radio medium by measuring a power of an uplink signal (e.g., a total uplink signal power) received over the radio medium (e.g., on RACH resources). The access node 100 may (e.g., dynamically) adjust or change the at least one threshold value (i.e., one or more coverage level thresholds) and/or other RACH parameters by means of the transmitting step 304. The at least one threshold value may be adjusted or changed such that the (e.g., total) received signal power is minimized. In this way, the access node 100 can control the coverage level and/or optimize the RACH parameters for the current situation (i.e., the current state or usage).

In other words, the total received power on the radio medium (e.g., in the RACH resources) is measured at the access node 100. The at least one threshold value and/or RACH parameters are adjusted or changed until the total received power on the radio medium (e.g., in the RACH resources) is minimized.

Controlling the coverage level based on the state of the radio medium (e.g., the total power on the RACH resources) can increase the probability for successful reception of a message from the radio device 200 over the radio medium (e.g., a RACH preamble or Msg1). Alternatively or in addition, an overall interference on the radio medium (e.g., on the RACH resources) can be reduced. Consequently, embodiments of the technique can reduce the amount of power used by the radio device 200 (e.g., a NB-IoT device) for the transmission of the message (e.g., for the RACH preamble transmission) and/or increase the number of radio devices 200 per time unit that can establish a radio link with the access node 100.

The technique may be implemented for NB-IoT, e.g., as specified by 3GPP, using frequency-division duplex (FDD), i.e., a downlink (DL) carrier and an uplink (UL) carrier are on different frequencies. The operation modes (e.g., as defined by 3GPP) for NB-IoT may include at least one of a stand-alone mode, a guard-band mode and an in-band mode. In stand-alone mode, the NB-IoT system (i.e., at least one embodiment of the radio device 200 and at least one embodiment of the access node 100 operative for NB-IoT) is operated in dedicated frequency bands. For in-band operation, the NB-IoT system can be placed inside the frequency bands used by current Long Term Evolution (LTE) systems. In the guard-band mode, the NB-IoT system can be placed in the guard band used by the current LTE system. NB-IoT can operate with a system bandwidth of 180 kHz. When multi-carriers are configured, several Physical Resource Blocks (PRBs) each having a spectral width of 180 kHz can be used, e.g., for increasing the system capacity, inter-cell interference coordination, load balancing, etc.

In any embodiment, the access node 100 may broadcast a Master Information Block (MIB, e.g., MIB-NB for NB-IoT) comprising essential system information (SI) used by the radio device 200 for receiving further SI in system information blocks (SIBs). SI on cell access, cell selection and scheduling information for further SIBs may be broadcasted in a SIB Type 1 (SIB1, e.g., SIB1-NB for NB-IoT). For example, configuration information for radio resources is carried in a SIB Type 2 (SIB2, e.g., SIB2-NB).

Dedicated physical channels, different from those of 3GPP LTE, are defined for enhanced MTC (eMTC) and for NB-IoT, e.g., a physical downlink control channel, which is referred to as MTC physical downlink control channel (MPDCCH) in eMTC and NB-IoT physical downlink control channel (NPDCCH) in NB-IoT, as well as a dedicated physical random access channel (PRACH), which is referred to as NPRACH for NB-IoT. SI for eMTC and NB-IoT is not dynamically scheduled in SI blocks SIB1-BR and SIB1-NB, respectively. Scheduling information is included in the Master Information Block (MIB) for MTC and MIB-NB for NB-IoT. Furthermore, SI messages with a fixed scheduling inside a SI window can be provided in SIB1-BR for MTC and in SIB1-NB for NB-IoT. Herein, the expressions MIB and SIB are collectively used for 3GPP LTE, MTC and NB-IoT.

In any aspect of the technique, the downlink signal may be a reference signal (RS). Based on measurements of the RS's received power (RSRP, e.g., NRSRP for NB-IoT), the UE 200 selects an entry coverage level (also: entry CE level), e.g., a coverage level to camp on a cell. Up to three different coverage levels (also: CE levels) are signaled via SI (e.g., SIB2-NB), e.g., Normal, Robust and Extreme.

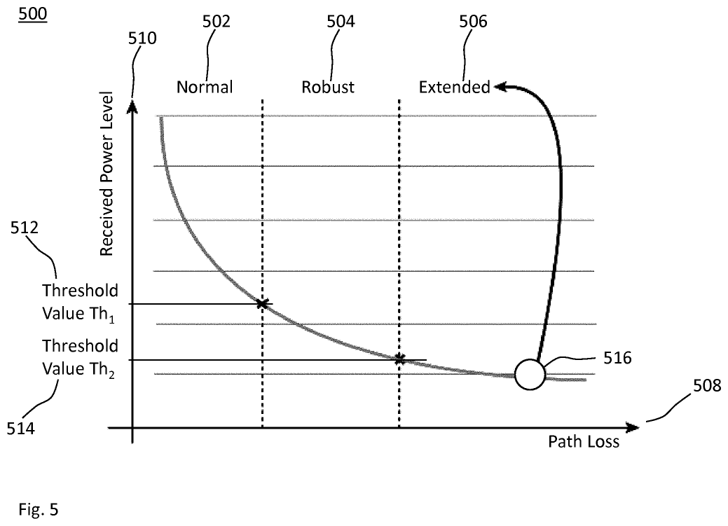

FIG. 5 schematically illustrates an implementation of the step 404 of selecting one of the coverage levels “Normal” 502, “Robust” 504 and “Extended” 506. Moreover, FIG. 5 schematically illustrates a relation 500 between a path loss 508 over the radio medium and the power 510 of the downlink signal received at the radio device 200 from the access node 100. The path loss 508 is the reduction in the power or power density (i.e., the attenuation) of the electromagnetic wave of the downlink signal as it propagates over the medium through the space from the access node 100 to the radio device 200.

The selection 404 of one of the coverage levels 502, 504 and 506 is based on the comparison between the threshold values 512 and 514 and the received power of the downlink signal. Since the received power 510 is related to the path loss 508, the coverage level 502, 504 or 506 is effectively selected according to the path loss 508.

In an NB-IoT implementation, the selection 404 of the CE level 502 to 506 depends on the NRSRP threshold levels, e.g., as shown in FIG. 5. Typical values for NRSRP threshold value 512 and 514 are Th1=144 dB and Th2=154 dB, respectively. In the example of FIG. 5, the received power is at reference sign 516, i.e., below the lowest threshold value 514, so that the “Extended” coverage level 506 is selected.

In any implementation, the selected coverage level may determine at least one of PRACH resources (e.g., NPRACH resources) to use for the RA procedure, a subset of subcarriers, a number of PRACH repetitions (i.e., RA preamble repetitions) and a maximum number of RA attempts. The RA preamble repetitions are used to achieve extra coverage, e.g., up to 20 dB compared to a baseline. The baseline may correspond to a single RA preamble transmission and/or the normal coverage level 502.

In any embodiment, the higher the coverage level, the greater may be the number of radio resources allocated for an uplink transmission from the radio device 200 to the access node 100 and/or for a downlink transmission from the access node 100 to the radio device 200.

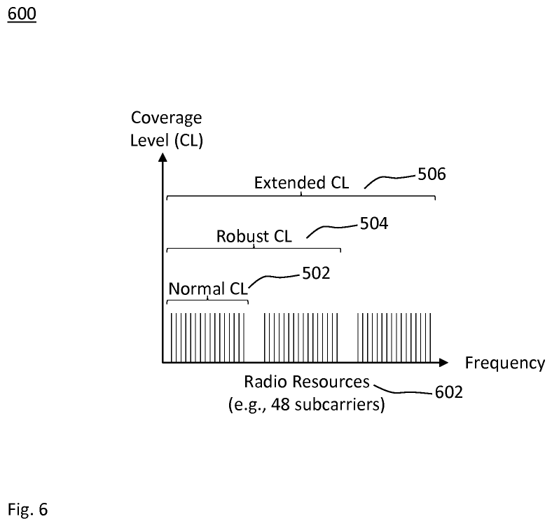

FIG. 6 schematically illustrates an example of the number of radio resources 602 that are used depending on the selected coverage level 502, 504 or 506. For example, the number of subcarriers may be changed depending on the selected coverage level.

Resources for the PRACH (e.g., the NPRACH) are an example for the radio resources 602 used depending on the selected coverage level. Based on measurements of the power of the received downlink signal (e.g., reference signal's received power, particularly NRSRP), the UE 200 select the entry CE level to camp on the corresponding cell. The radio resources (e.g., NPRACH resources) are provided for each CE group separately. The CE group may comprise the set of radio devices served by (including camping on) the access node or its cell according to the same CE level (i.e., the same selected coverage level).

Depending on the selected coverage level, the radio resources (e.g., the NPRACH resources) are assigned in time and/or frequency resources and/or occur periodically. Periodicities for the radio resources (e.g., NPRACH periodicities) between 40 ms and 2.56 s may be configured by the access node 100 for the radio device 200. A start time for each NPRACH resource (e.g., for a certain CE group) within a period is provided in SI. The number of repetitions (of the RA preamble) and the preamble format determine the end of the NPRACH resource.

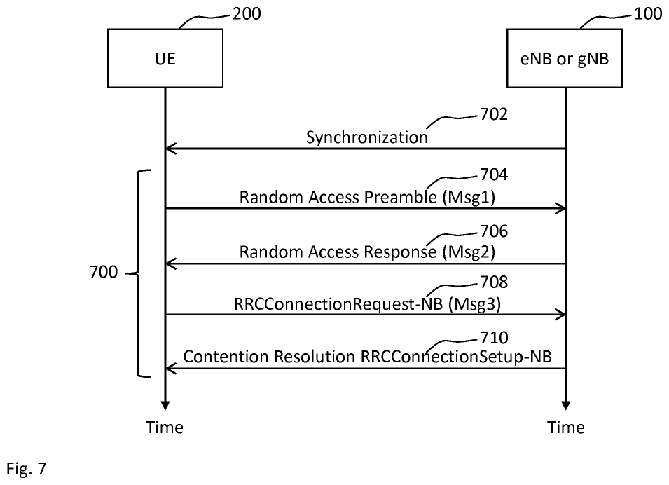

FIG. 7 schematically illustrates a signaling diagram for a RA procedure 700 (e.g., a NB-IoT RA procedure), which may be performed by the radio device 200 according to the received control information, e.g., after downlink synchronization 702. The RA Preamble (RAP) may be repeated according to the selected coverage level, e.g., 1 time, 2, 4, 8, 16, 32, 64 or 128 times.

The system acquisition procedure is in general the same for eMTC and NB-IoT as for LTE. The UE 200 first achieves downlink synchronization 702 by reading a primary synchronization signal (PSS) and a secondary synchronization signal (SSS). The UE 200 reads the MIB, then SIB1, and finally the SI-messages are acquired (each possibly containing multiple SIBs). The radio device 200 is brought information (e.g. on essential information required to receive SIBs), in the MIB (e.g., MIB-NB). Information on cell access and selection and other SIB scheduling information is brought in SIB1 (e.g., SIB1-NB, and radio resource configuration information is typically carried in SIB2 (e.g., SIB2-NB).

Once the UE 200 has read the associated SIB information, the UE 200 may start the RA procedure 700, e.g., to establish or re-establish a radio resource control (RRC) connection with the access node 100.

In any cellular system (e.g., 3GPP LTE, MTC and NB-IoT), the radio device 200 acting as a terminal has to request a connection setup by transmitting a selected preamble sequence, i.e., the RA preamble. Such a connection setup is referred to as RA procedure or RACH process 700. The document 3GPP TS 36.300 (e.g., version 10.1.5) defines various triggers that let the UE 200 initiate a RACH process 700, such as, powering on the UE 200 to act as a terminal. The document 3GPP TS 36.211 (e.g., version 15.3.0) and the document 3GPP TS 36.321 (e.g., version 15.3.0), particularly in section 5 therein, describe when a UE 200 transmits on the RACH.

When the UE 200 attempts to establish a radio link over the radio medium (e.g., a state transition from an RRC_IDLE state to an RRC_CONNECTED state), as described in the document 3GPP TS 36.321, subclause 5.1.1 (e.g., version 15.3.0), the UE 200 selects a RA preamble and requests RA to the access node 100 (e.g., a eNB or gNB) by transmitting the RA preamble 704, as schematically shown in FIG. 7. The RA preamble 704 is also referred to as message 1 or Msg1.

For a contention-based RA procedure 700, the UE 200 selects one of 64 available RACH preambles 704 as Msg1 and also needs to give an identity to the RAN (i.e., the access node 100) so that the RAN is enabled to address the UE 200 in the next step. The identity used by the UE 200 is called RA radio network temporary identity (RA-RNTI). The RA-RNTI is determined from the time slot number in which the RA preamble 704 is sent. If the UE 200 does not receive any response from the RAN (i.e., the access node 100), the UE 200 sends the RACH preamble 704 again with higher output power (which is also referred to as power ramping).

The access node 100 (e.g., an eNB or gNB) sends a RA Response (RAR) 706 to the UE 200, e.g., on a Downlink Shared Channel (DL-SCH) addressed to the RA-RNTI, as explained for the Msg1. The RAR 706 is also referred to as RACH response, message 2 or Msg2.

The RAR 706 carries a Temporary Cell RNTI (TC-RNTI or temporary C-RNTI), a Timing Advance (TA) value and an uplink grant for an uplink resource. The access node 100 (e.g., a eNB) assigns another identity to UE 200, namely the TC-RNTI for further communication. Further, the access node 100 informs the UE 200 to change its timing using the TA value in order to compensate for the round trip delay caused by the distance from the access node 100 to the UE 200. The access node 100 assigns an initial resource and an uplink grant for said resource to the UE 200 so that it can use an uplink shared channel (UL-SCH).

Using the UL-SCH, the UE 200 transmits a message 708 indicative of the RRC connection request to the access node 100 (e.g., an eNB). The message 708 is also referred to as message 3 or Msg3. During this phase, the UE 200 is identified by the temporary C-RNTI, which is assigned by the access node 100 in the Msg2, i.e., the RAR 706. The message 708 may further contain at least one of an UE identity for the UE 200 and a connection establishment cause value. The UE identity may be a Temporary Mobile Subscriber Identity (TMSI) or a random value.

The TMSI is used if the UE 200 has previously been connected to the same network (e.g., to the same RAN and/or the same core network connected to the RAN). With the TMSI value, the UE 200 is identified in the core network. A random value is used if UE is connecting for the first time to the network. The random value or TMSI enables the network to distinguish between UEs when the same TC-RNTI has been assigned to more than one UE (e.g., in the case of a RA collision). Furthermore, the connection establishment cause value is indicative or a reason why the UE 200 needs to connect to the RAN.

Due to a RA collision, the access node (e.g., an eNB) might not respond to a RRC Connection Request 708. If the UE 200 (i.e., the terminal) does not receive the RACH response 706 at the first trial, the UE 200 just retries (i.e., retransmits) a RA preamble 704.

The access node 100 (e.g., an eNB or gNB) responds with a contention resolution message 710 to the UE 200 whose RRC Connection request 708 was successfully received. This message is addressed towards the TMSI value or the random number, and the TC-RNTI is promoted to a C-RNTI, which is used for the further communication.

In any embodiment, the SI (e.g., SIB2) may comprise the control information that is indicative of the at least one threshold value. While an example of an NB-IoT implementation is described herein below, similar means for the transmission 304 and the reception 402 of the control information may be implemented for any other radio access technology, particularly for 3GPP LTE or NR, including MTC.

For an exemplary NB-IoT implementation, SIB2-NB may comprise entries associated with narrowband preamble ramping (e.g., as implementations of the coverage levels) as shown below. Moreover, the at least one threshold value used for the selection 404 of the coverage level may comprise RSRP thresholds that are signaled in the SIB2-NB.

An example definition for the SIB2-NB is outlined below. Definitions particularly usable for implementing the control information are underlined.

| | |
|---|---|
| SystemInformationBlockType2-NB-r13 ::= | SEQUENCE { |
| radioResourceConfigCommon-r13 | RadioResourceConfigCommonSIB-NB-r13, |
| ue-TimersAndConstants-r13 | UE-TimersAndConstants-NB-r13, |
| freqInfo-r13 | SEQUENCE { |
| ul-CarrierFreq-r13 | CarrierFreq-NB-r13 |
| additionalSpectrumEmission-r13 | AdditionalSpectrumEmission |

},

| | |
|---|---|
| timeAlignmentTimerCommon-r13 | TimeAlignmentTimer, |

multiBandInfoList-r13 SEQUENCE (SIZE (1..maxMultiBands)) OF
AdditionalSpectrumEmission

| | |
|---|---|
| lateNonCriticalExtension | OCTET STRING |

...
},

Therein, the common RRC configuration in the SIB2-NB may further comprise:

RadioResourceConfigCommonSIB-NB-r13 ::= SEQUENCE {

| | |
|---|---|
| rach-ConfigCommon-r13 | RACH-ConfigCommon-NB-r13, |
| bcch-Config-r13 | BCCH-Config-NB-r13, |
| pcch-Config-r13 | PCCH-Config-NB-r13, |
| nprach-Config-r13 | NPRACH-ConfigSIB-NB-r13, |
| npdsch-ConfigCommon-r13 | NPDSCH-ConfigCommon-NB-r13, |
| npusch-ConfigCommon-r13 | NPUSCH-ConfigCommon-NB-r13, |
| dl-Gap-r13 | DL-GapConfig-NB-r13 |
| uplinkPowerControlCommon-r13 | UplinkPowerControlCommon-NB-r13, |

...
},

In the common RRC configuration, the RACH configuration may comprise:

| | |
|---|---|
| RACH-ConfigCommon-NB-r13 ::= | SEQUENCE { |
| preambleTransMax-CE-r13 | PreambleTransMax, |
| powerRampingParameters-r13 | PowerRampingParameters, |
| rach-InfoList-r13 | RACH-InfoList-NB-r13, |
| connEstFailOffset-r13 | INTEGER (0..15) OPTIONAL, -- |

Need OP
...
}

In the common RRC configuration, the NRACH configuration may further comprise:

| | |
|---|---|
| NPRACH-ConfigSIB-NB-r13 ::= | SEQUENCE { |
| nprach-CP-Length-r13 | ENUMERATED {us66dot7, us266dot7}, |
| rsrp-ThresholdsPrachInfoList-r13 | RSRP-ThresholdsNPRACH-InfoList-NB-r13 |
| nprach-ParametersList-r13 | NPRACH-ParametersList-NB-r13 |

},

In the NRACH configuration, the at least one threshold value (e.g., 512 and 514) may be implemented as a list of (e.g., up to 3) threshold values:

RSRP-ThresholdsPrachInfoList-r13 ::= SEQUENCE (SIZE(1..3)) OF
RSRP-Range

In the NRACH configuration, the radio resources (e.g., 602) for the NPRACH may be configured according:

| | |
|---|---|
| NPRACH-ParametersList-NB-r13 ::= | SEQUENCE (SIZE (1.. maxNPRACH-Resources-NB- |

r13))

of NPRACH-Parameters-NB-r13,

wherein:

| | |
|---|---|
| NPRACH-Parameters-NB-r13::= | SEQUENCE { |
| nprach-Periodicity-r13 | ENUMERATED {ms40, ms80, ms160, ms240, |
| | ms320, ms640, ms1280, |

ms2560},

| | |
|---|---|
| nprach-StartTime-r13 | ENUMERATED {ms8, ms16, ms32, ms64, |
| | ms128, ms256, ms512, |

ms1024},

| | |
|---|---|
| nprach-SubcarrierOffset-r13 | ENUMERATED {n0, n12, n24, n36, n2, n18, |

n34, spare1},

| | |
|---|---|
| nprach-NumSubcarriers-r13 | ENUMERATED {n12, n24, n36, n48}, |
| nprach-SubcarrierMSG3-RangeStart-r13 | ENUMERATED {zero, oneThird, twoThird, |

one},

| | |
|---|---|
| maxNumPreambleAttemptCE-r13 | ENUMERATED {n3, n4, n5, n6, n7, n8, |

n10, spare1},

| | |
|---|---|
| numRepetitionsPerPreambleAttempt-r13 | ENUMERATED {n1, n2, n4, n8, n16, n32, |

n64, n128},

| | |
|---|---|
| npdcch-NumRepetitions-RA-r13 | ENUMERATED {r1, r2, r4, r8, r16, r32, |

r64, r128,

```
    r256, r512, r1024, r2048,
    spare4, spare3, spare2,
```

spare1},

| | |
|---|---|
| npdcch-StartSF-CSS-RA-r13 | ENUMERATED {v1dot5, v2, v4, v8, v16, |

v32, v48, v64},

| | |
|---|---|
| npdcch-Offset-RA-r13 | ENUMERATED {zero, oneEighth, oneFourth, |

threeEighth}
}

Further embodiments are describe below, each of which can be combined with any one of the afore-mentioned aspects and embodiments and/or any other of the below-describe embodiments. Particularly, below-described features and steps for estimating, measuring and/or taking into account of the state and/or the usage of the radio medium (particularly interference on the radio medium) and/or the state and/or the usage of the access node (particularly a load of the access node) may be implemented in any embodiment of the access node 100 (e.g., a eNB) for the determining step 302. Based on the result of the determining step 302, the at least one threshold value (e.g., the NRSRP thresholds) may adjusted or changed by means of the transmitting step 304. The embodiments are described below using NB-IoT terminology for conciseness only, and can equally well be applied to any other radio access technology, particularly NR and LTE for MTC (LTE-M), which includes eMTC.

Furthermore, in any embodiment, the optimal threshold values (e.g., NRSRP thresholds) may be determined using a self-organizing network (SON) algorithm, e.g., for determining optimal RACH parameters (particularly, the NRSRP thresholds).

In a first embodiment, the eNB 100 determines in the step 302 cell load levels and takes corresponding 24-hour variations into account when selecting and transmitting NRSRP thresholds in the step 304. As an example, an eNB 100 may find from historical data stored by the specific eNB that busy NB-IoT time is, e.g., 00:00 h to 00:12 h every weekday. During that time, the eNB 100 foresees more NB-IoT related interference and that its connected radio devices 200 can benefit from using a higher coverage level. The eNB 100 may therefore signal in the step 304 decreased NRSRP 50 thresholds during the busy time by means of the control information.

In a second embodiment, the eNB 100 determines in the step 302 cell load levels when selecting the threshold values or other parameters for controlling the coverage level, for example as schematically represented by below pseudocode:

IF cell_load<load_threshold:
Use default one or more threshold values (e.g., default NRSRP thresholds) for coverage level selection

ELSEIF cell_load>load_threshold:
Use a margin of X dB compared to the one or more default threshold values (i.e., reduce the one or more threshold values by X dB).

ENDIF

The margin or offset X may be any suitable non-negative value. The cell load (labeled “cell-load”, e.g., a “cell_NB_load” for NB-IoT) may be defined or measured by at least one of: the number of radio devices (e.g., embodiments of the radio device 200) that accesses the cell or the access node 100 per time unit, an average session lengths (e.g., per radio device 200) in a radio resource control (RRC) connected (RRC_CONNECTED) mode and an amount of data transmitted and/or received in UL and/or DL.

In a third embodiment, the eNB 100 determines in the step 302 a combination of long-term average cell load levels (for example based on historical data) and an interference measure. The interference may be defined as the average interference on the uplink carrier.

The NRSRP thresholds (NRSRP threshold value Th1 and NRSRP threshold value Th2 shown in FIG. 5) are selected based on the combination of cell load and interference considered by the eNB.

In the fourth embodiment, the eNB 100 determines in the step 302 a combination of long-term average cell load levels, for example based on historical data, and an interference measure. The interference measure may be based on a signal to interference and noise ratio (SINR). For example, the NRSRP thresholds (e.g., the NRSRP Threshold 512, Th1, and the NRSRP Threshold 514, Th2, shown in FIG. 5) are selected or calculated based on the combination of cell load and interference determined by the eNB 100 in the step 302.

In a fifth embodiment, e.g., based on the third or fourth embodiment, but with a second threshold value Th2 (e.g., the NRSRP threshold 514 in FIG. 5) fixed to be Y dB greater than a first threshold value (e.g., the NRSRP Threshold Th1 in FIG. 5). The level Y dB may for example be 10 dB.

In a sixth embodiment, alternatively or in addition to counting all radio devices 200 that access the cell or access node 100 (e.g., the eNB), the access node 100 may count accesses per coverage level, e.g., based on the RA preambles that the radio devices 200 (e.g., UEs) selected for their RA attempts. Thus, the access node 100 is able to determine (e.g., estimate and/or compare) cell loads for different parts (e.g., different portions) of the cell.

Alternatively or in combination, cell loads or cell load patterns between (e.g., neighboring) embodiments of the access nodes 100 (e.g., eNBs) may be compared. For example, information on the load is shared between the access nodes 200 (e.g., over a backhaul link or an X2 interface). Optionally, this measure may be combined with a simple measure of total received power for each coverage level and/or for each cell, e.g., since the estimated load in terms of correctly received RA preambles 1o may decrease in an extreme case when the load increases due to overload.

Alternatively or in addition to any of the afore-mentioned aspects and embodiments, the state and/or the usage of the radio medium may be determined in the step 302 based on an uplink measurement. By transmitting or receiving the control information in the step 304 or 402, respectively, the at least one threshold value and/or at least one RA parameter (for example, any RACH parameter) may be optimized based on the determined state and/or usage.

An implementation of the method 300 may control one or more embodiments of the radio device 200 (e.g., by means of the transmitted control information) to select optimal RACH parameters in the step 404 and/or may transmit in the step 304 the control information being indicative of optimal RACH parameters. The RACH parameters may be optimal in that a total received power on the radio medium (e.g., on the time-frequency resources allocated to RA preamble transmission) and/or in the cell is reduced or minimized, e.g., for a given or unchanged number of radio devices 200. The total received power on the radio medium and/or in the cell may be reduced or minimized for each of the different coverage levels.

The one or more RACH parameters, which may be optimized by implementations of the methods 300 and 400, respectively, may comprise at least one of the following examples (without being limited thereto). A first example for the RACH parameter is the at least one threshold value (e.g., the Th1 and Th2 signaled in SIB2-NB) for selecting the coverage level. A second example for the RACH parameter is a number of RA attempts before the coverage level is increased. A third example for the RACH parameter is a number of repetitions of the RA preamble or repetitions of a RACH resource (e.g., the number of NPRACH repetitions) per RA attempt.

The one or more values of any one or each of the one or more RACH parameters may be set in the step 302 or 304 by the access node 100 (e.g., the eNB) and signaled to the one or more radio devices 200 (e.g., an NB-IoT device) by means of the control information in the step 304 and 402 (e.g. through SIB2-NB).

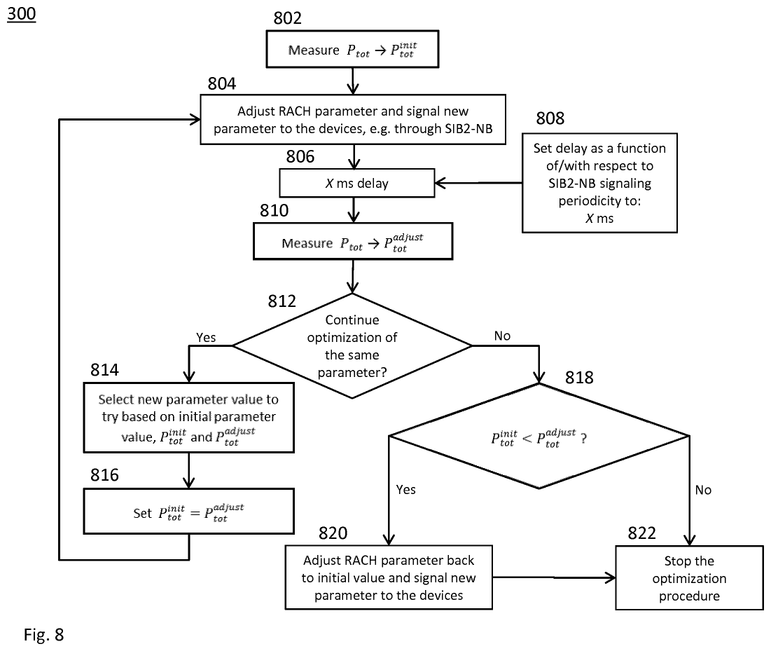

FIG. 8 shows a schematic flowchart for an implementation of the method 300 for optimizing one or more RA parameters (e.g., RACH parameters). The one or more RACH parameters may comprise the at least one threshold value (e.g., for controlling the selection 404 of the coverage level).

While the implementation of the method 300 is described for an access node 100 (e.g., an eNB) providing or controlling radio access for one or more NB-IoT devices (e.g., as embodiments of the radio device 200), the RACH parameter optimization may be readily implemented in any other radio environment or for other radio access technologies. Particularly, the NPRACH resources may be replaced by any other radio resources of the radio medium, e.g., any PRACH resources.

The total received power in the NPRACH resources allocated to the different coverage levels (e.g., different CE levels) is measured in a step 802, e.g., as a substep of the step 302. The measurement 802 may be an average over a number of the periodically scheduled NPRACH resources, e.g., to improve statistics. The averaging length may be set according to capabilities of the radio device 200 (e.g., UE capabilities), a radio environment and/or a geo-position.

The measurements 802 include noise and interference in addition to the power of the received RACH preambles (which is an example for the uplink signal). It may be assumed that the sum of noise and interference stays constant (e.g., essentially constant) over the time period during which the method 300 and/or 400 is applied. The measured total received power is denoted by Pₜₒₜ^{init}.

In a step 804, e.g., a substep of the step 304, the one or more RACH parameter are changed or adjusted. Furthermore, the one or more changed or adjusted values are signaled to the radio device 200 in the control information, e.g. through signaling over SIB2-NB.

For example, one or more RACH parameters are changed or adjusted such that RACH performance is optimized or likely to be improved, e.g., based on a simplified radio access model in the step 804. The one or more initial values of the RACH parameter are kept for reference.

The model may account for changing parameters related to RACH power control, since that change may reduce the total received power in the RACH resources without a corresponding improvement in RACH performance. For example, any change or adjustment (i.e., modification) of a parameter “preambleInitialReceivedTargetPower” can impact or influence the total received power in the RACH resources. The model may account for such a change or adjustment in the comparison of the received power before and/or after the change or adjustment. Alternatively, power settings may be kept constant.

A delay is introduced in a step 806 to make sure that each of the one or more radio devices 200 has received the one or more changed or adjusted RACH parameter values. The delay may correspond to a SIB2-NB signaling time period according to the step 808. If RACH parameters introducing a delay between the moment where the radio device 200 receives data to transmit and the moment where the first RACH attempts starts are modified, the total received power may be reduced simply because there are fewer RACH attempts being started. When applying the proposed algorithm to optimize the value of such parameters, a sufficient delay may be allowed so that the average RACH load has stabilized.

The total received power in the NPRACH resources allocated to the different coverage levels (i.e., the different CE levels) is measured again in a step 810, which may be implemented as a further substep of the step 302. The measured total received power is denoted by Pₜₒₜ^{adjust}.

If further optimization of the same parameter is not desired at the branching point 812, the initial received power Pₜₒₜ^{init} is compared to the received power Pₜₒₜ^{adjust} after the change or adjustment of the RA parameter in a step 818. If Pₜₒₜ^{init}<Pₜₒₜ^{adjust}, the respective RA parameter is adjusted or changed back to the initial value of the respective RA parameter in a step 820, since the initial value was better in terms of total RACH preamble transmission power. The re-adjusted or back-changed value of the respective RA parameter, e.g., the initial RA parameter value, is signaled in the control information to the one or more radio devices, e.g., as a further substep of the step 304. Either cases of the branching point 818 may lead to stopping or pausing the optimization procedure until a next optimization time instance, which is shown as a step 822.

If the RA parameter should be further optimized in the branching point 812, a further parameter value to test is determined in a step 814. The further parameter value may be a function of at least one of the initial value of the respective RA parameter, the adjusted value of the respective RA parameter, the initially measured power Pₜₒₜ^{init} and the power Pₜₒₜ^{adjust} measured resulting from the adjusted value.

In a step 816, the initial power is set to the power Pₜₒₜ^{adjust} measured after adjusting the RA parameter, Pₜₒₜ^{init}=Pₜₒₜ^{adjust}, since Pₜₒₜ^{adjust} corresponds to the total received power for the initial parameter setting when proceeding with the optimization procedure. This second parameter setting combined with its corresponding total received power is kept for later reference when selecting new parameter values to try.

the optimization procedure is repeated from the step 804 in which the RACH parameter is adjusted.

As stated above, a simple implementation of the method 300 as an optimization procedure described above considers total received power on all RACH resources and is, thus, not suitable for optimization of certain RA parameters related to RACH power control and/or RACH time-frequency resources. In a further implementation of the method 300 as an optimization procedure, the average received power per RACH subcarrier is measured instead. The further implementation can for example be used to optimize the number of RACH subcarriers allocated for each coverage level.

In a still further implementation, the average number of received RA preambles per time unit (or time instant) is also measured. If the average received power per RACH subcarrier decreases with a certain change or adjustment of the respective RA parameter while the average number of received RA preambles stays (e.g., essentially) constant, the adjusted or changed RA parameter setting is preferred (e.g., kept). However, if the average received power per RACH subcarrier decreases while the average number of received RACH preambles also decreases, it is possible that the reduced transmit power for RA preambles was the reason for fewer successfully received RA preambles (e.g., and not the received power decreased due to less radio device 200 wanting to access the access node 100). In the latter case, the initial RA parameter setting may be restored.

Below-described example implementation of the method 300 may be combined with any one of the aspects, embodiments or implementations described above. The implementation of the method 300 explains how the threshold values Th1 and Th2 (e.g., 512 and 514) for the selection 404 of the coverage level can be adjusted using the method 300.

The total received power in the NPRACH resources allocated to the different coverage levels (i.e., the different CE levels) is measured according to the step 302. The resulting measured total received power is denoted by Pₜₒₜ^{init}. Optionally, the number of correctly received RA preambles during the time period in which the received power has been measured is also stored.

In the step 304, the access node 100 decides how to adjust the values for the threshold levels such that RACH performance is likely to be improved. The threshold values (Th1 and Th2) may be adjusted one at a time or together.

In one example, the step 304 may comprise trying to increase and/or decrease the respective threshold values, and measure how total received power changes, e.g., in the step 810.

In another example for the step 304 (which can be more accurate and also more complex), the one or more threshold values (to be indicated in the control information) are changed or adjusted using a typical average received power per correctly received RA preamble as adjustment threshold.

If the total received power per preamble in a certain one of the coverage levels is above the adjustment threshold, the number of collisions during preamble transmissions is unnecessarily high. Thus, the threshold values are adjusted to reduce the number of RA attempts with the certain one coverage level. If the power per RA preamble is above the adjustment threshold for all coverage levels, it may be better to increase the amount of time-frequency resources (for example the number of subcarriers) used for RA. In the latter case, the threshold values Th1 and Th2 may be kept.

Alternatively or in addition, if the total received power per preamble in a certain one of the coverage levels is below the adjustment threshold, there are few collisions during preamble transmissions. Thus, the threshold values may be changed or adjusted to spread the RA attempts more evenly over the coverage levels and/or the number of subcarriers used for the RACH may be reduced.

The changed or adjusted threshold value are signal (i.e., transmitted) to the one or more radio device 200 according to the step 304, e.g. through signaling over SIB2-NB. The initial value of each of the changed or adjusted threshold value is kept for reference.

A delay is introduced to make sure that each of the one or more radio devices 200 has received the parameter values indicated in the control information.

The total received power in the NPRACH resources allocated to the different coverage enhancements (CEs) is measured again, e.g., in the step 810. The measured total received power is denoted by Pₜₒₜ^{adjust}.

The initial received power Pₜₒₜ^{init} is compare to the received power Pₜₒₜ^{adjust} after change or adjustment of the one or more threshold values, e.g., in the step 818. If Pₜₒₜ^{init}<Pₜₒₜ^{adjust}, the new threshold values for the CE levels are likely worse than the initial threshold values. Another value may then be tested. Alternatively, the procedure can be stopped after the threshold values are changed back to the initial values and these threshold values have been signaled to the radio devices 200 according to the step 304.

If Pₜₒₜ^{init}≥Pₜₒₜ^{adjust}, the changed or adjusted threshold values are likely better than the initial threshold values. Optionally, another value may still be tested to further refine the threshold values. Alternatively, the procedure can be stopped.

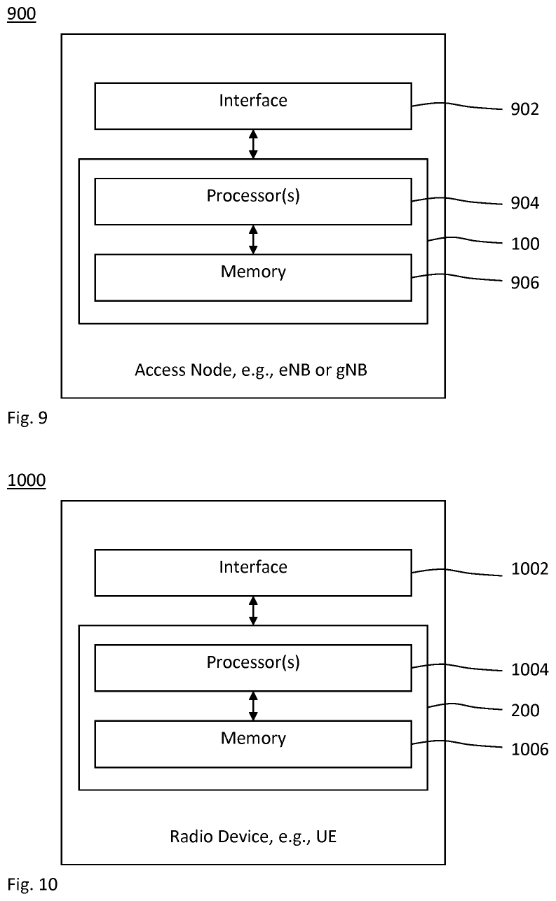

FIG. 9 shows a schematic block diagram for an embodiment of the device 100. The device 100 comprises one or more processors 904 for performing the method 300 and memory 906 coupled to the processors 904. For example, the memory 906 may be encoded with instructions that implement at least one of the modules 102 and 104.

The one or more processors 904 may be a combination of one or more of a microprocessor, controller, microcontroller, central processing unit, digital signal processor, application specific integrated circuit, field programmable gate array, or any other suitable computing device, resource, or combination of hardware, microcode and/or encoded logic operable to provide, either alone or in conjunction with other components of the device 100, such as the memory 906, access node functionality (e.g., base station functionality). For example, the one or more processors 904 may execute instructions stored in the memory 906. Such functionality may include providing various features and steps discussed herein, including any of the benefits disclosed herein. The expression “the device being operative to perform an action” may denote the device 100 being configured to perform the action.

As schematically illustrated in FIG. 9, the device 100 may be embodied by an access node 900, e.g., functioning as an eNB or gNB. The access node 900 comprises a radio interface 902 coupled to the device 100 for radio communication with one or more radio devices and/or one or more (e.g., neighboring) access nodes.

FIG. 10 shows a schematic block diagram for an embodiment of the device 200. The device 200 comprises one or more processors 1004 for performing the method 400 and memory 1006 coupled to the processors 1004. For example, the memory 1006 may be encoded with instructions that implement at least one of the modules 202 and 204.

The one or more processors 1004 may be a combination of one or more of a microprocessor, controller, microcontroller, central processing unit, digital signal processor, application specific integrated circuit, field programmable gate array, or any other suitable computing device, resource, or combination of hardware, microcode and/or encoded logic operable to provide, either alone or in conjunction with other components of the device 200, such as the memory 1006, radio device functionality (e.g., UE functionality). For example, the one or more processors 1004 may execute instructions stored in the memory 1006. Such functionality may include providing various features and steps discussed herein, including any of the benefits disclosed herein. The expression “the device being operative to perform an action” may denote the device 200 being configured to perform the action.

As schematically illustrated in FIG. 10, the device 200 may be embodied by a radio device 1000, e.g., functioning as a UE. The radio device 1000 comprises a radio interface 1002 coupled to the device 200 for radio communication with one or more access nodes (e.g., base stations) and/or one or more radio devices.

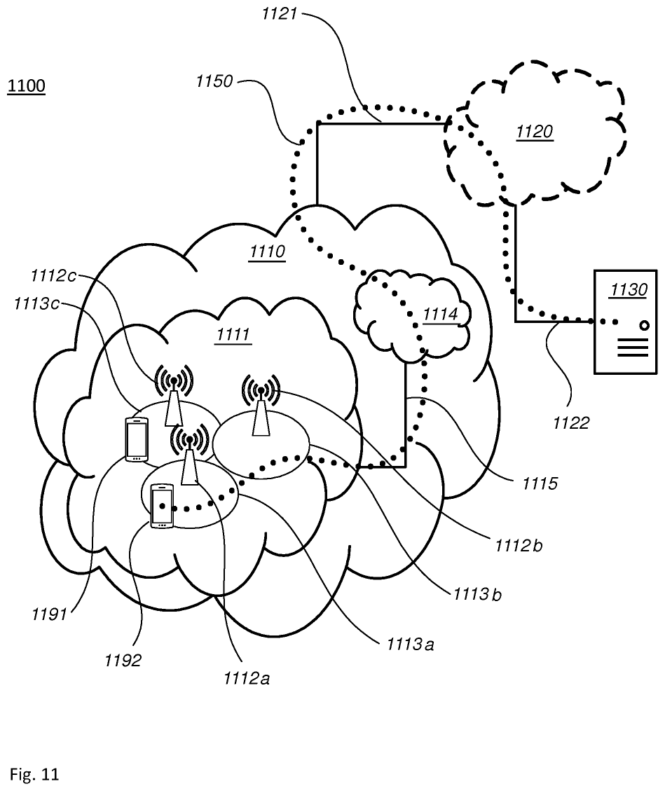

With reference to FIG. 11, in accordance with an embodiment, a communication system 1100 includes a telecommunication network 1110, such as a 3GPP-type cellular network, which comprises an access network 1111, such as a radio access network, and a core network 1114. The access network 1111 comprises a plurality of base stations 1112a, 1112b, 1112c, such as NBs, eNBs, gNBs or other types of wireless access points, each defining a corresponding coverage area 1113a, 1113b, 1113c. Each base station 1112a, 1112b, 1112c is connectable to the core network 1114 over a wired or wireless connection 1115. A first user equipment (UE) 1191 located in coverage area 1113c is configured to wirelessly connect to, or be paged by, the corresponding base station 1112c. A second UE 1192 in coverage area 1113a is wirelessly connectable to the corresponding base station 1112a. While a plurality of UEs 1191, 1192 are illustrated in this example, the disclosed embodiments are equally applicable to a situation where a sole UE is in the coverage area or where a sole UE is connecting to the corresponding base station 1112.

The telecommunication network 1110 is itself connected to a host computer 1130, which may be embodied in the hardware and/or software of a standalone server, a cloud-implemented server, a distributed server or as processing resources in a server farm. The host computer 1130 may be under the ownership or control of a service provider, or may be operated by the service provider or on behalf of the service provider. The connections 1121, 1122 between the telecommunication network 1110 and the host computer 1130 may extend directly from the core network 1114 to the host computer 1130 or may go via an optional intermediate network 1120. The intermediate network 1120 may be one of, or a combination of more than one of, a public, private or hosted network; the intermediate network 1120, if any, may be a backbone network or the Internet; in particular, the intermediate network 1120 may comprise two or more sub-networks (not shown).

The communication system 1100 of FIG. 11 as a whole enables connectivity between one of the connected UEs 1191, 1192 and the host computer 1130. The connectivity may be described as an over-the-top (OTT) connection 1150. The host computer 1130 and the connected UEs 1191, 1192 are configured to communicate data and/or signaling via the OTT connection 1150, using the access network 1111, the core network 1114, any intermediate network 1120 and possible further infrastructure (not shown) as intermediaries. The OTT connection 1150 may be transparent in the sense that the participating communication devices through which the OTT connection 1150 passes are unaware of routing of uplink and downlink communications. For example, a base station 1112 may not or need not be informed about the past routing of an incoming downlink communication with data originating from a host computer 1130 to be forwarded (e.g., handed over) to a connected UE 1191. Similarly, the base station 1112 need not be aware of the future routing of an outgoing uplink communication originating from the UE 1191 towards the host computer 1130.

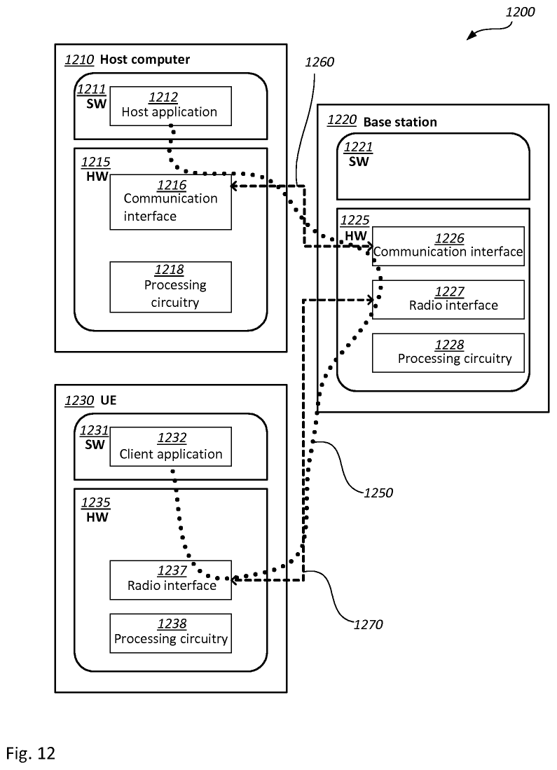

Example implementations, in accordance with an embodiment, of the UE, base station and host computer discussed in the preceding paragraphs will now be described with reference to FIG. 12. In a communication system 1200, a host computer 1210 comprises hardware 1215 including a communication interface 1216 configured to set up and maintain a wired or wireless connection with an interface of a different communication device of the communication system 1200. The host computer 1210 further comprises processing circuitry 1218, which may have storage and/or processing capabilities. In particular, the processing circuitry 1218 may comprise one or more programmable processors, application-specific integrated circuits, field programmable gate arrays or combinations of these (not shown) adapted to execute instructions. The host computer 1210 further comprises software 1211, which is stored in or accessible by the host computer 1210 and executable by the processing circuitry 1218. The software 1211 includes a host application 1212. The host application 1212 may be operable to provide a service to a remote user, such as a UE 1230 connecting via an OTT connection 1250 terminating at the UE 1230 and the host computer 1210. In providing the service to the remote user, the host application 1212 may provide user data which is transmitted using the OTT connection 1250.

The communication system 1200 further includes a base station 1220 provided in a telecommunication system and comprising hardware 1225 enabling it to communicate with the host computer 1210 and with the UE 1230. The hardware 1225 may include a communication interface 1226 for setting up and maintaining a wired or wireless connection with an interface of a different communication device of the communication system 1200, as well as a radio interface 1227 for setting up and maintaining at least a wireless connection 1270 with a UE 1230 located in a coverage area (not shown in FIG. 12) served by the base station 1220. The communication interface 1226 may be configured to facilitate a connection 1260 to the host computer 1210. The connection 1260 may be direct or it may pass through a core network (not shown in FIG. 12) of the telecommunication system and/or through one or more intermediate networks outside the telecommunication system. In the embodiment shown, the hardware 1225 of the base station 1220 further includes processing circuitry 1228, which may comprise one or more programmable processors, application-specific integrated circuits, field programmable gate arrays or combinations of these (not shown) adapted to execute instructions. The base station 1220 further has software 1221 stored internally or accessible via an external connection.

The communication system 1200 further includes the UE 1230 already referred to. Its hardware 1235 may include a radio interface 1237 configured to set up and maintain a wireless connection 1270 with a base station serving a coverage area in which the UE 1230 is currently located. The hardware 1235 of the UE 1230 further includes processing circuitry 1238, which may comprise one or more programmable processors, application-specific integrated circuits, field programmable gate arrays or combinations of these (not shown) adapted to execute instructions. The UE 1230 further comprises software 1231, which is stored in or accessible by the UE 1230 and executable by the processing circuitry 1238. The software 1231 includes a client application 1232. The client application 1232 may be operable to provide a service to a human or non-human user via the UE 1230, with the support of the host computer 1210. In the host computer 1210, an executing host application 1212 may communicate with the executing client application 1232 via the OTT connection 1250 terminating at the UE 1230 and the host computer 1210. In providing the service to the user, the client application 1232 may receive request data from the host application 1212 and provide user data in response to the request data. The OTT connection 1250 may transfer both the request data and the user data. The client application 1232 may interact with the user to generate the user data that it provides.

It is noted that the host computer 1210, base station 1220 and UE 1230 illustrated in FIG. 12 may be identical to the host computer 1130, one of the base stations 1112a, 1112b, 1112c and one of the UEs 1191, 1192 of FIG. 11, respectively. This is to say, the inner workings of these entities may be as shown in FIG. 12 and independently, the surrounding network topology may be that of FIG. 11.

In FIG. 12, the OTT connection 1250 has been drawn abstractly to illustrate the communication between the host computer 1210 and the use equipment 1230 via the base station 1220, without explicit reference to any intermediary devices and the precise routing of messages via these devices. Network infrastructure may determine the routing, which it may be configured to hide from the UE 1230 or from the service provider operating the host computer 1210, or both. While the OTT connection 1250 is active, the network infrastructure may further take decisions by which it dynamically changes the routing (e.g., on the basis of load balancing consideration or reconfiguration of the network).

The wireless connection 1270 between the UE 1230 and the base station 1220 is in accordance with the teachings of the embodiments described throughout this disclosure. One or more of the various embodiments improve the performance of OTT services provided to the UE 1230 using the OTT connection 1250, in which the wireless connection 1270 forms the last segment. More precisely, the teachings of these embodiments may reduce the latency and improve the data rate and thereby provide benefits such as better responsiveness.

A measurement procedure may be provided for the purpose of monitoring data rate, latency and other factors on which the one or more embodiments improve. There may further be an optional network functionality for reconfiguring the OTT connection 1250 between the host computer 1210 and UE 1230, in response to variations in the measurement results. The measurement procedure and/or the network functionality for reconfiguring the OTT connection 1250 may be implemented in the software 1211 of the host computer 1210 or in the software 1231 of the UE 1230, or both. In embodiments, sensors (not shown) may be deployed in or in association with communication devices through which the OTT connection 1250 passes; the sensors may participate in the measurement procedure by supplying values of the monitored quantities exemplified above, or supplying values of other physical quantities from which software 1211, 1231 may compute or estimate the monitored quantities. The reconfiguring of the OTT connection 1250 may include message format, retransmission settings, preferred routing etc.; the reconfiguring need not affect the base station 1220, and it may be unknown or imperceptible to the base station 1220. Such procedures and functionalities may be known and practiced in the art. In certain embodiments, measurements may involve proprietary UE signaling facilitating the host computer's 1210 measurements of throughput, propagation times, latency and the like. The measurements may be implemented in that the software 1211, 1231 causes messages to be transmitted, in particular empty or “dummy” messages, using the OTT connection 1250 while it monitors propagation times, errors etc.

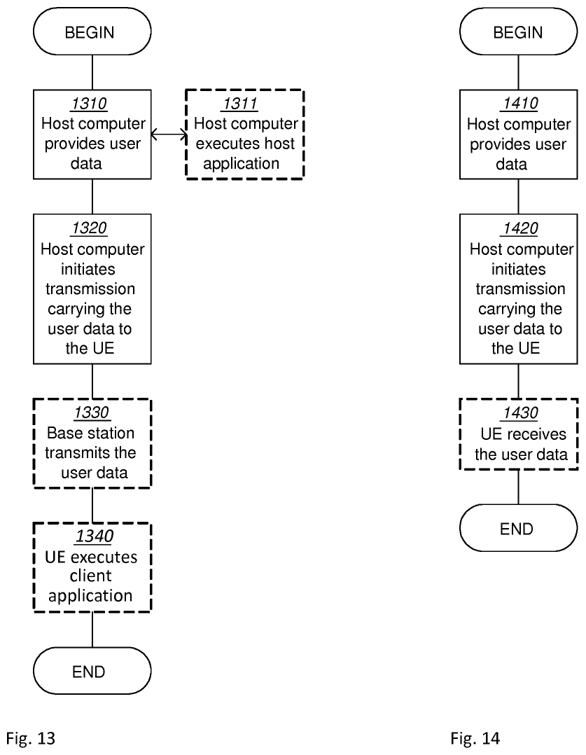

FIG. 13 is a flowchart illustrating a method implemented in a communication system, in accordance with one embodiment. The communication system includes a host computer, a base station and a UE which may be those described with reference to FIGS. 11 and 12. For simplicity of the present disclosure, only drawing references to FIG. 13 will be included in this section. In a first step 1310 of the method, the host computer provides user data. In an optional substep 1311 of the first step 1310, the host computer provides the user data by executing a host application. In a second step 1320, the host computer initiates a transmission carrying the user data to the UE. In an optional third step 1330, the base station transmits to the UE the user data which was carried in the transmission that the host computer initiated, in accordance with the teachings of the embodiments described throughout this disclosure. In an optional fourth step 1340, the UE executes a client application associated with the host application executed by the host computer.

FIG. 14 is a flowchart illustrating a method implemented in a communication system, in accordance with one embodiment. The communication system includes a host computer, a base station and a UE which may be those described with reference to FIGS. 11 and 12. For simplicity of the present disclosure, only drawing references to FIG. 14 will be included in this section. In a first step 1410 of the method, the host computer provides user data. In an optional substep (not shown) the host computer provides the user data by executing a host application. In a second step 1420, the host computer initiates a transmission carrying the user data to the UE. The transmission may pass via the base station, in accordance with the teachings of the embodiments described throughout this disclosure. In an optional third step 1430, the UE receives the user data carried in the transmission.

As has become apparent from above description, embodiments of the technique enable a more accurate coverage level selection using the at least one threshold value (e.g., NRSRP thresholds) that are controlled by means of the transmitted control information. The at least one threshold value may be changed or adjusted to control the coverage level selection for load and/or interference.

Same or further embodiments can reduce the power consumption of the radio device (e.g., a UE or NB-IoT device). Alternatively or in addition, interference induced in a cell can be reduced and/or efficiency of the radio medium (e.g., at a total system level) can be improved. For example, embodiments of the radio devices that would otherwise be in outage during periods of high interference can access the cell or network.

Alternatively or in addition, embodiments enable the access node (e.g., a base station, particularly an eNB or gNB) to dynamically optimize RACH parameters, e.g., such that the probability of successful reception of the RACH preamble (RAP or Msg 1) is increased and/or the overall interference on the RACH resources is reduced. This will in turn reduce the amount of power used by the radio devices (e.g., NB-IoT devices) for RACH preamble transmission and increase the number of radio devices per time unit that can establish a radio link with the access node.

1-65. (canceled)

66. A method of controlling a coverage level for a radio device connected or connectable to an access node over a radio medium, the method comprising:
determining a state or usage of at least one of the radio medium and the access node; and
transmitting control information to the radio device, wherein
the control information is indicative of at least one threshold value that depends on the determined state or usage for controlling the coverage level selected by the radio device based on a comparison of power of a downlink signal received over the radio medium from the access node with the at least one threshold value.

67. The method of claim 66, wherein the at least one threshold value depends on the determined state or usage of the radio medium at the access node or the determined state or usage of the access node over the radio medium.

68. The method of claim 66, wherein the determined state or usage of the radio medium or the determined state or usage of the access node comprises or relates to at least one of:
a load of the access node over the radio medium;
a number of radio links over the radio medium, which are terminated at the access node;
an occupancy of the radio medium at the access node;
an interference level on the radio medium at the access node or in a cell served by the access node; or
a collision rate on the radio medium at the access node.

69. The method of claim 68, wherein the interference level on the radio medium is based on a signal to interference and noise ratio.

70. The method of claim 68, wherein the radio medium comprises an uplink carrier to the access node, and wherein the interference level is based on an average interference on the uplink carrier at the access node.

71. The method of claim 66, wherein the state or usage of the radio medium is determined based on a power of an uplink signal received over the radio medium at the access node.

72. The method of claim 66, wherein the at least one threshold value is decreased if a channel quality as the determined state of the radio medium decreases or the determined usage increases, and/or wherein the controlled coverage level is increased responsive to an increase in a channel quality as the determined state of the radio medium or an increase in the determined usage.

73. The method of claim 66, wherein controlling the coverage level comprises or initiates, at the access node, allocating radio resources for a transmission over the radio medium to the access node, wherein the allocated radio resources depend on the coverage level selected at the radio device based on the control information.

74. The method of claim 66, further comprising the step of:
receiving a message from the radio device over the radio medium at the access node according to the controlled coverage level.

75. The method of claim 74, wherein radio resources used for the reception of the message depend on the controlled coverage level.

76. The method of claim 74, wherein the reception of the message uses at least one of a robustness and a redundancy according to the controlled coverage level.

77. A method of selecting a coverage level for a radio device connected or connectable to an access node over a radio medium, the method comprising:
receiving control information from the access node, wherein the control information is indicative of at least one threshold value that depends on a state or usage of at least one of the radio medium and the access node; and
selecting the coverage level based on a comparison of power of a downlink signal received over the radio medium from the access node with the at least one threshold value.

78. The method of claim 77, wherein the at least one threshold value depends on the state or usage of the radio medium at the access node or the state or usage of the access node over the radio medium.

79. The method of claim 77, wherein the state or usage of the radio medium or the state or usage of the access node comprises or relates to at least one of:
a load of the access node over the radio medium;
a number of radio links over the radio medium, which are terminated at the access node;
an occupancy of the radio medium at the access node;
an interference level on the radio medium at the access node or in a cell served by the access node; or
a collision rate on the radio medium at the access node.

80. The method of claim 79, wherein the interference level on the radio medium is based on a signal to interference and noise ratio.

81. The method of claim 79, wherein the radio medium comprises an uplink carrier to the access node, and wherein the interference level is based on an average interference on the uplink carrier at the access node.

82. The method of claim 77, wherein the state or usage of the radio medium is determined based on a power of an uplink signal received over the radio medium at the access node.

83. The method of claim 82, wherein the uplink signal comprises a random access preamble transmitted from the radio device and at least one of noise and interference.

84. The method of claim 77, wherein the at least one threshold value is decreased if a channel quality as the state of the radio medium decreases or the usage increases, and/or wherein the controlled coverage level is increased responsive to an increase in a channel quality as the state of the radio medium or an increase in the usage.

85. The method of claim 77, further comprising:
allocating radio resources for a transmission over the radio medium to the access node, wherein the allocated radio resources depend on the selected coverage level.

86. A device for controlling a coverage level for a radio device connected or connectable to an access node over a radio medium, the device being configured to:
determine a state or usage of at least one of the radio medium and the access node; and
transmit control information to the radio device, wherein the control information is indicative of at least one threshold value that depends on the determined state or usage for controlling the coverage level selected by the radio device based on a comparison of power of a downlink signal received over the radio medium from the access node with the at least one threshold value.

87. A device for selecting a coverage level for a radio device connected or connectable to an access node over a radio medium, the device being configured to:
receive control information from the access node, wherein the control information is indicative of at least one threshold value that depends on a state or usage of at least one of the radio medium and the access node; and
select the coverage level based on a comparison of power of a downlink signal received over the radio medium from the access node with the at least one threshold value.
